(19) United States
(12) Patent Application Publication
(10) Pub. No.: US 2013/0195449 A1
(43) Pub. Date: Aug. 1, 2013

(54) Contentionless Add-Drop Multiplexer

(71) Applicants: Lorenzo Ghioni, Casalmaiocco (LO) (IT); Maurizio Gazzola, Milano (IT); Ronald Johnson, San Ramon, CA (US); Stefano Piciaccia, Milano (IT)

(72) Inventors: Lorenzo Ghioni, Casalmaiocco (LO) (IT); Maurizio Gazzola, Milano (IT); Ronald Johnson, San Ramon, CA (US); Stefano Piciaccia, Milano (IT)

(73) Assignee: CISCO TECHNOLOGY, INC., San Jose, CA (US)

(21) Appl. No.: 13/363,660

(22) Filed: Feb. 1, 2012

(51) Int. Cl. H04J 14/02

(52) U.S. Cl. 398/48

(57) ABSTRACT

An optical add/drop module of a reconfigurable optical add/drop multiplexer node includes a first set of optical switches configured to receive respective first optical signals, at respective channel receive ports, to be added to a first wave division multiplexed optical signal and to direct the first optical signals to, in a first state, at least one fully functional transmit degree port, and in a second state, to at least one partially functional transmit degree port; and a second set of optical switches configured to receive respective second optical signals to be dropped from a second wave division multiplexed signal via, in a first state, a fully functional receive degree port, and in a second state, via a partially functional receive degree port, and to direct the second optical signals to respective channel transmit ports. An auxiliary device can be used to make the partially functional ports fully functional.

### TECHNICAL FIELD

The present disclosure relates to optical networking.

### BACKGROUND

An optical add-drop multiplexer (OADM) node comprises a collection of optical and control devices used in wavelength-division multiplexing systems for multiplexing and routing different channels of light into or out of, e.g., one or more multiple single mode fibers (SMFs). The terms “add” and “drop” in the context of an OADM node refer to the capability of the OADM node to add one or more new wavelengths, channels or colors to an existing multi-wavelength wavelength division multiplexed (WDM) or dense WDM (DWDM) signal, and/or to drop (remove) one or more channels from the WDM or DWDM signal. An OADM node may be considered to be a specific type of optical cross-connect.

A reconfigurable OADM (ROADM) node is a form of OADM node that includes the ability to remotely switch or control traffic in a DWDM system, e.g., via software control (whereas OADM nodes are considered to have fixed add/drop capabilities with respect to, e.g., colors or direction). As such, a ROADM node enables increased flexibility in network transport by allowing a telecommunications provider to add or drop any channel, under remote control. In this way, a ROADM node allows for very flexible, remote selection and routing of wavelengths transiting a given node on a fiber network. Similarly, a ROADM node may also allow flexible access to any of the wavelengths going through the node for use of the data on the chosen wavelength and the possibility of adding to, or modifying, the data on that wavelength for transmitting it on to the next node(s). A ROADM node may also allow the interconnection of multiple intersecting networks (multiple degree nodes) at the optical level, avoiding the expense and complexity of optical-electrical-optical conversions to achieve the interconnection. Thus, as the demand in a given network changes, additional or different channels can be dropped or added, under remote control, creating a flexible optical network provisioning system.

### BRIEF DESCRIPTION OF THE DRAWINGS

FIG. 1 depicts a ROADM node including a contentionless add/drop module having auxiliary optical transmit degree ports and auxiliary optical receive degree ports.

FIG. 2 depicts a schematic block diagram of the contentionless add/drop module shown in FIG. 1.

FIG. 3 depicts a schematic block diagram of an auxiliary device that complements the auxiliary optical transmit degree ports and auxiliary optical receive degree ports of the contentionless add/drop module.

FIG. 4 shows a ROADM node including the contentionless add/drop module of FIG. 2 and the auxiliary device of FIG. 3.

FIG. 5 depicts an example optical fiber cabling arrangement for interconnecting the contentionless add/drop module, auxiliary device and other components of a ROADM node.

FIG. 6 is a flowchart illustrating example operations that may be performed using the contentionless add/drop module and associated auxiliary device.

### DESCRIPTION OF EXAMPLE EMBODIMENTS

Overview

In one embodiment an apparatus includes a first set of optical switches configured to receive respective first optical signals, at respective channel receive ports, to be added to a first wave division multiplexed optical signal and to direct the first optical signals to, in a first state, at least one fully functional transmit degree port, and in a second state, to at least one partially functional transmit degree port; and a second set of optical switches configured to receive respective second optical signals to be dropped from a second wave division multiplexed signal via, in a first state, a fully functional receive degree port, and in a second state, via a partially functional receive degree port, and to direct the second optical signals to respective channel transmit ports. The apparatus may be configured as an optical add/drop module of a reconfigurable optical add/drop multiplexer.

Example Embodiments

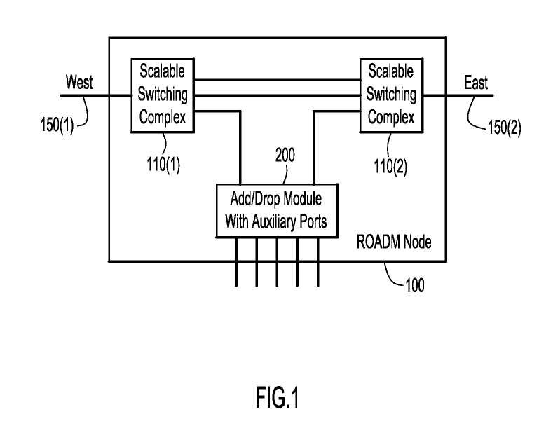

FIG. 1 depicts a ROADM node 100 including scalable switching complexes 110(1) and 110(2) and a contentionless add/drop multiplexer or module 200 with auxiliary degree ports. These components may be configured to pass optical signals of selected bandwidth, e.g., beginning at 50 GHz and selectively increasing that bandwidth by 25 GHz to 75 GHz, 100 GHz, etc. In one embodiment, ROADM node 100 includes a scalable switching complex 110(1) that faces a “west” direction and a scalable switching complexes 110(2) that faces an “east” direction. In this configuration, ROADM node 100 is a ROADM node having two degrees, where each degree represents a direction to which the node may connect. Add/drop module 200 is configured to add or drop particular wavelengths, channels or colors to, or from, a given multiplexed optical signal. As will be explained later herein, add/drop module 200 is configured with additional, upgrade, or “auxiliary” degree ports that can be leveraged to enable the add/drop module 200 to handle an increased number of individual degrees, and thus enable the entirety of the ROADM node 100 to be scaled in a relatively simple manner.

More specifically, in a ROADM node 100 like that depicted in FIG. 1, an optical fiber 150(1), such as a single mode fiber (SMF), may be connected to the ROADM node's west facing direction. This optical fiber 150(1) may carry a wave division multiplexed (WDM) or dense (DWDM) optical signal comprising a plurality of wavelengths, channels or colors (hereinafter, collectively, “channels”). Optical fiber 150(1) may carry channels towards the ROADM node 100, and likewise may carry channels away from ROADM node 100.

One or more of the multiple channels being carried by optical fiber 150(1) may be dropped at ROADM node 100 via add/drop module 200 Likewise, one or more channels can be added to the optical fiber 150(1) for transmission to another optical node, as long as that channel is not already in use.

A similar optical fiber 150(2) may be in communication with scalable switching complex 110(2). Optical fiber 150(2) may carry channels to and from the east direction. These channels may also be added to or dropped by the add/drop module 200.

Express channels, i.e., those channels not being added or dropped at the ROADM node 100, can pass directly from, e.g., scalable switching complex 110(1) to scalable switching complex 110(2).

As shown in FIG. 1, the add/drop module 200 is in communication with each degree of the ROADM node 100. In one possible implementation, the ROADM node 100 may be configured as acolorless, directionless and contentionless ROADM node. A service is defined as colorless if a channel can be set under software control and is not fixed by a physical add/drop port. Colorless service may be realized by providing a tunable wavelength source and by implementing an add/drop structure that is not color specific. When a channel can be added or dropped from/to any direction (under remote or software control), the implementation is referred to as directionless. Finally, a contentionless architecture allows multiple copies of the same channel on a single add/drop structure. Thus, in a colorless, directionless and contentionless ROADM node implementation, a service can be assigned its color and direction without any restrictions as long as the channel is available at the network level for that direction (i.e., that degree). ROADM node 100 may also support a capability to define a channel based on, e.g., a preselected granularity such that a given channel might have a minimum bandwidth of, e.g. 50 GHz and that bandwidth can be incremented by 25 GHz steps to, e.g., 75 GHz, 100 GHz, etc. This capability, referred to herein as “flexspectrum,”enables the ROADM node 100 to accommodate custom channel spacing as well as bit rates and modulation formats.

In the case of the example ROADM node 100 of FIG. 1, there are only two degrees. However, those skilled in the art will appreciate that the number of degrees in a ROADM node consistent with the principles described herein is not limited and is, instead, dependent on the desired number of incoming and outgoing optical fibers 150. Indeed, some ROADM nodes have grown to have on the order of tens of degrees. ROADM nodes of that caliber, however, can be very expensive to deploy, and in many cases, a given telecommunication provider may not need to deploy a ROADM node of that magnitude in early phases of an optical network build out. For example, during the early stages of an optical network build out, perhaps only a four degree ROADM node would be sufficient to support the desired connectivity. However, at some subsequent time, additional degrees may be desired. Embodiments described herein provide an upgradable add/drop module that can enable a telecommunication provider to more easily expand or increase the number of degrees that a given ROADM node, and particularly a given add/drop module 200, can support. Moreover, this expansion, when implemented, need not impact any then-running traffic.

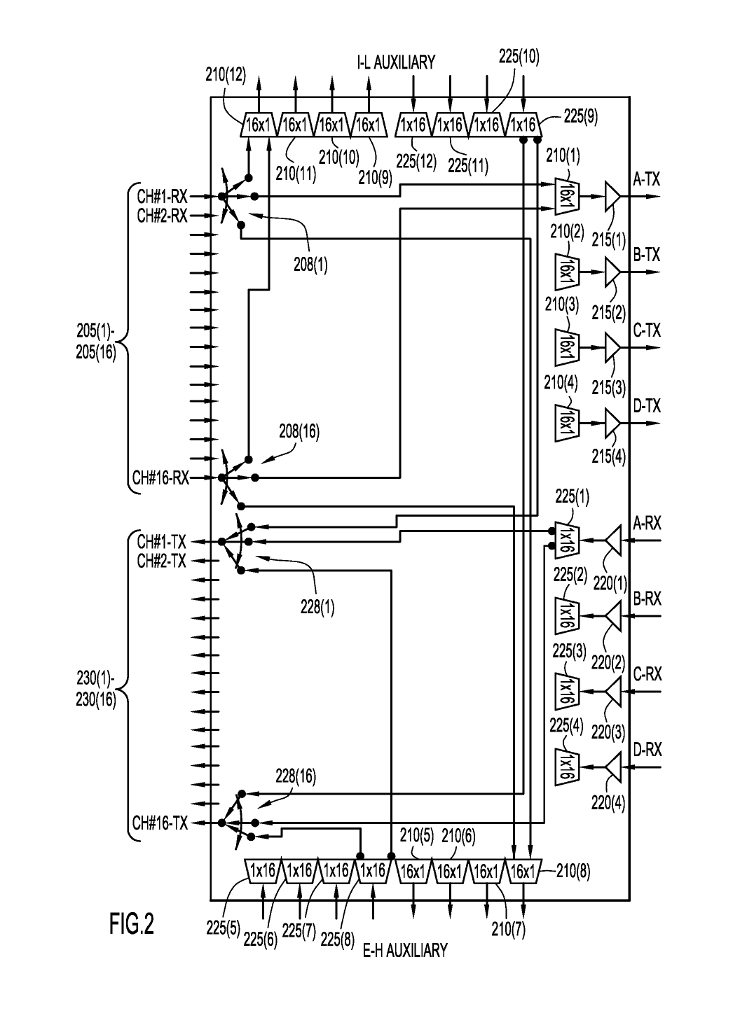

Reference is now made to FIG. 2, which depicts a schematic block diagram of the add/drop module 200 shown in FIG. 1. Add/drop module 200 comprises multiple input and output ports and internal optical switching functionality. More specifically, the add/drop module 200 shown in FIG. 2 is configured as a fully functional 4×16 contentionless, flexspetrum-capable, add/drop module along with infrastructure to upgrade or expand the add/drop module 200 to an 8×16 or 12×16 contentionless add/drop module. In the “M×N” nomenclature used here, M refers to the number of degrees supported, and N refers to the number of individual channels that can be added or dropped by the module.

The structure to support the 4×16 add/drop functionality includes a plurality of receive channel ports 205(1)-205(16). Receive channel ports 205 are connection points for optical channels that are to be added to a given optical fiber exiting the ROADM node 100 for transmission to another optical node where it may be, e.g., dropped or passed through as an express channel. The receive channel ports 205 are in optical communication with respective optical switches 208(1)-208(16). Optical switches 208 are configured to receive an optical signal from a given receive channel port 205 and, under remote or software control, direct the optical signal toward at least one of M degrees of the ROADM node 100. Switches 208 may be, e.g., microelectonic minors or planar lightwave circuits that may be employed to selectively route wavelengths from one port to another. Those skilled in the art will appreciate that other optical switching technologies may be employed in connection with embodiments described herein.

Transmit degree ports A-D (A-TX, B-TX, etc.) of the 4×16 fully functional portion of the add/drop module 200 comprise a respective 16×1 coupler 210(1)-210(4) and associated optical amplifiers 215(1)-215(4).

Receive degree ports A-D (A-RX, B-RX, etc.) of the 4×16 fully functional portion of the add/drop module 200 comprise a respective optical amplifier 220(1)-220(4) and a corresponding 1×16 splitter 225(1)-225(4). Splitters 225 are in communication with optical switches 228(1)-228(16). Switches 228 may also be microelectonic mirrors or planar lightwave circuits that may be employed to selectively route channels from a degree receive port to any one of the transmit channel ports 230(1)-230(16).

With the 4×16 fully functional configuration depicted, any channel received at any channel receive port 205 can be routed to any transmit degree port A-D for transmission to another node outside of ROADM node 100. Similarly, any channel received at any of receive degree ports A-D can be dropped via channel transmit ports 230(1)-230(16).

In addition to degrees A-D (M=4), which support both transmit (TX) and receive (RX) segments, the add/drop module 200 comprises structure to enable the number of degrees (i.e., degree ports) to be increased in a modular fashion. As further shown in FIG. 2, auxiliary receive and transmit degree ports E-H and I-L are provided. Auxiliary degree ports E-H comprise transmit degree ports that include couplers 210(5)-210(8) and receive degree ports that include splitters 225(5)-225(8). Similarly, auxiliary degree ports I-L comprise transmit degree ports that include couplers 210(9)-210(12) and receive degree ports that include splitters 225(9)-225(12).

Notably, auxiliary degree ports E-H and I-L are not fully functional because those ports do not include, e.g., optical amplifiers 215, 220 as do degree ports A-D. On the other hand, as schematically shown, each channel receive port 205 is configured, via its associated optical switch 208 to be optically coupled with, not only any one of transmit degree ports A-D, but also any of auxiliary transmit degree ports E-H and I-L. Likewise, receive degree ports A-D, as well as any of the auxiliary receive degree ports E-H and I-L can be configured to be in communication with any of channel transmit ports 230. In other words, the add/drop module 200 is configured such that any channel can be routed to any port (i.e., any channel can be added), and any optical signal received via any degree port can be routed to any channel transmit port (i.e., any channel can be dropped). Significantly, however, a subset of the ports are not fully operational.

Fielding add/drop module 200, where not all degree ports are fully functional, can result in considerable cost savings, since, e.g., in an add/drop module, optical amplifiers can be relatively expensive components as compared to other components in the add/drop module. On the other hand, by fielding an add/drop module as described herein with degree ports that are already accessible via the several optical switches 208 and 228, the number of degrees that can be supported by the optical add/drop module 200 can be upgraded or increased as described below without impacting any running traffic passing to and from already-connected degrees.

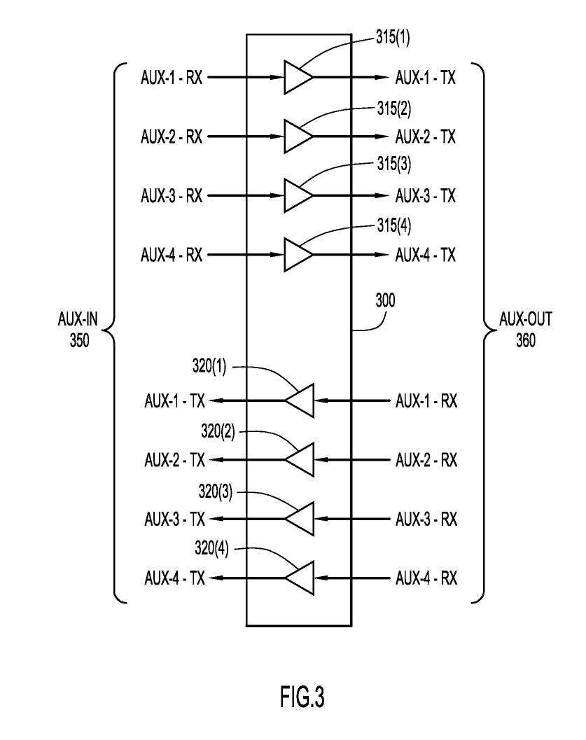

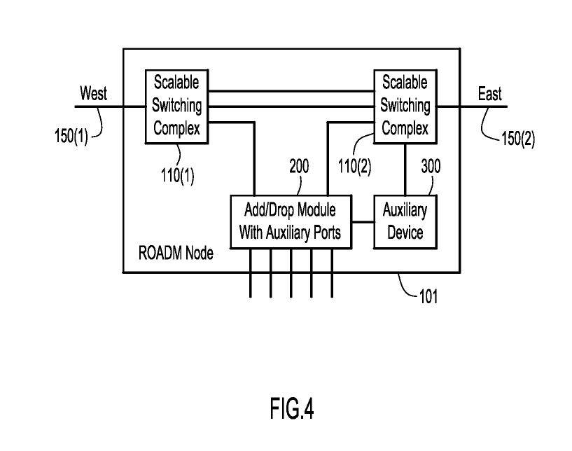

FIG. 3 depicts a schematic block diagram of an auxiliary device 300 that complements the auxiliary degree ports E-H and I-L of the add/drop module 200. In one possible embodiment, add/drop module 200 and auxiliary device 300 are mounted relatively closely to one another in a rack such that relatively short optical cables can be used to connect the devices as shown in FIG. 4 (described more fully below). With reference, first, to FIG. 3, auxiliary device 300 comprises a plurality of optical amplifiers 315(1)-315(4) and 320(1)-320(4). One such auxiliary device 300 can thus support and complement all of the auxiliary degree ports E-H or I-L shown in FIG. 2. That is, coupler 210(5), for example, can be optically connected, via, e.g., an optical cable, to an input of optical amplifier 315(1). The output of optical amplifier 315(1) might then be connected in such a way as to be in optical communication with a scalable switching complex 110 of a given degree of ROADM node 100.

In a similar fashion, a scalable switching complex 110 of a given degree of ROADM node 100 may be configured to be in optical communication with an input side of optical amplifier 320(1) of auxiliary device 300 and an output of optical amplifier 320(1) may be configured to be in optical communication with splitter 225(5).

When configured in such a way, the combination of the respective optical amplifiers 315, 320 within auxiliary device 300 and respective auxiliary degree ports E-H (and/or I-L) become functionally equivalent to degree ports A-D. That is, each degree port E-H and I-L is now configured with an optical amplifier that enables each of those ports to operate in the same manner as any of degree ports A-D. This expansion of the number of supportable degrees (i.e., enabled or fully functional degree ports) is particularly beneficial as the number of degrees to be supported by a given ROADM node increases. Because the add/drop module 200 itself already includes the optical switching infrastructure to support all of the auxiliary degree ports, it is a relatively simple upgrade task to enable all of the degree ports to be fully functional, and to do so without impacting any traffic then passing through the add/drop module 200.

FIG. 4 shows a ROADM node 101 including the auxiliary device 300. As shown, scalable switching complexes 110(1), 110(2) are in optical communication with one another (for express channel communication), and with add/drop module 200 for optical add/drop functionality. In addition, auxiliary device 300 is optically connected between add/drop module 200 and scalable switching complex 110(2). Those skilled in art will appreciate, however, that outputs of the auxiliary device 300 may also be in communication with scalable switching complex 110(1), but such connections are not shown to simplify the drawing.

With the deployment of a single auxiliary device 300, the add/drop module 200 can be converted to an 8×16 add/drop module, wherein degree ports A-D and auxiliary degree ports E-H are fully operational or functional. With the addition of yet another auxiliary device 300, auxiliary degree ports I-L can also become fully operational, such that the add/drop module 200 (in combination with two auxiliary devices 300) can operate as a 12×16 add/drop module. In other words, when two auxiliary devices 300 are deployed, a fully functional 12 degree×16 channel add/drop module is realized. Stated alternatively, as more auxiliary devices 300 are employed, the number of degrees that can be supported increases. The number of supported channels (16 in this example case) remains the same.

The modular approach described herein wherein an auxiliary device 300 can be used to fully enable ports of an add/drop module enables a telecommunications provider to field in a ROADM node an add/drop module with a predetermined level of service, and then, when circumstances dictate, additional ports can be brought on-line by connecting an auxiliary device 300 in-line with the auxiliary degree ports without impacting already-running optical services.

Those skilled in the art will appreciate that the specific configuration of add/drop module 200 described herein is only for purposes of this description. That is, an add/drop module configured in accordance with embodiments described herein need not be limited to having, upon initial deployment, four fully functional degree ports. Instead, an add/drop module consistent with the principles described herein could also be configured to have additional fully functional ports to support an increased number of degrees, e.g., the add/drop module could be configured to have any number of fully functional ports, with, e.g., 6, 8 or 10 fully functional ports being possible. Also, the number of auxiliary degree ports arranged in the add/drop module 200 need not be limited to two sets of four degrees, but instead can be configured to have any number of sets of auxiliary degree ports, and the number of ports per set can also be modified as may be desired.

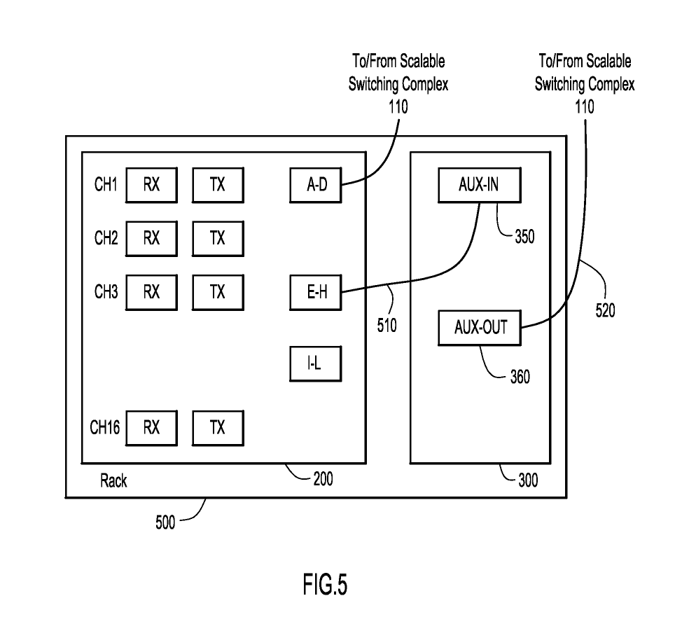

FIG. 5 shows an example configuration of cabling between the add/drop module 200 and one auxiliary device 300 that may be mounted together in a single equipment rack 500 for convenience. The optical cables themselves may be ribbon optical cables with MPO-type connectors. Such connectors are compatible ribbon fiber connectors based on an MT ferrule which allow quick and reliable connections for up to 12 fibers. Taking auxiliary degree ports E-H as an example, these ports comprise four auxiliary transmit degree ports and four auxiliary receive degree ports, for a total of eight connections. With a ribbon fiber that can support up to 12 fibers, it is thus possible to group all eight of these connections in a single ribbon fiber. As such, a single ribbon cable connection 510 can be employed to connect all of the auxiliary degree ports E-H to an auxiliary device AUX-IN port 350 (e.g., that supports an MPO-type connector) and another single ribbon cable connection 520 can be used to connect the auxiliary device 300 with, e.g., a scalable switching complex 110. An AUX-OUT port 360 on auxiliary device 300 may be used for this purpose.

In one embodiment, all of the ports (e.g., 205, 230, A-D, E-H, I-L, 350, 360) are configured to be accessible on a faceplate of respective rack-mounted components. In this way, cabling between, e.g., the add/drop module 200 and auxiliary device 300, and between the auxiliary device 300 and a given scalable switching complex 110 (or, perhaps, a patch panel (not shown)), is simplified and easily accessible to a technician or network manager.

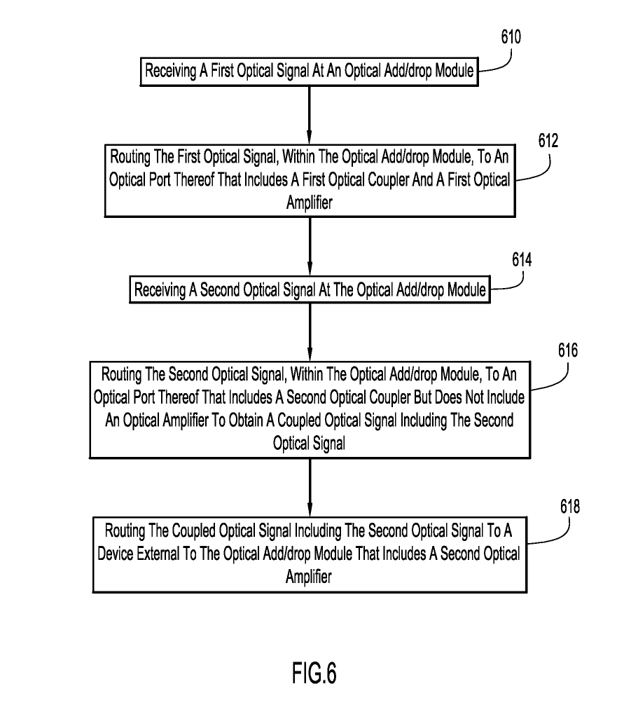

FIG. 6 is a flowchart illustrating example operations that may be performed using the contentionless add/drop module and associated auxiliary device. At 610 an operation includes receiving a first optical signal at an optical add/drop module. At 612 an operation includes routing the first optical signal, within the optical add/drop module, to an optical port thereof that includes a first optical coupler and a first optical amplifier. At 614, an operation includes receiving a second optical signal at the optical add/drop module. At 616, an operation includes routing the second optical signal, within the optical add/drop module, to an optical port thereof that includes a second optical coupler but does not include an optical amplifier to obtain a coupled optical signal including the second optical signal. At 618, an operation includes routing the coupled optical signal including the second optical signal to a device external to the optical add/drop module that includes a second optical amplifier.

Stated alternatively, operation of the add/drop module 200 and auxiliary device 300 enables channels to be added or dropped using any one of the fully functional degree ports A-D, and enables channels to be added or dropped using any one of the partially functional degree ports E-H or I-L by leveraging the functionality of auxiliary device 300. In one possible embodiment, the optical add/drop module 200 and the device external to the optical add/drop module (e.g., auxiliary device 300) are deployed or arranged in a same equipment rack.

Thus, an embodiment of an add/drop module described herein provides a first set of optical switches configured to receive respective first optical signals, at respective channel receive ports, to be added to a first wave division multiplexed optical signal and to direct the first optical signals to, in a first state, at least one fully functional transmit degree port, and in a second state, to at least one partially functional transmit degree port; and a second set of optical switches configured to receive respective second optical signals to be dropped from a second wave division multiplexed signal via, in a first state, a fully functional receive degree port, and in a second state, via a partially functional receive degree port, and to direct the second optical signals to respective channel transmit ports.

In one implementation the at least one fully functional transmit degree port comprises an optical coupler and an optical amplifier arranged in series. Similarly, the at least one fully functional receive degree port comprises an optical amplifier and an optical splitter arranged in series. Further, “partially functional” may be defined as not comprising an optical amplifier.

In the indicated implementation the partially functional transmit degree port may be configured to be in optical communication with an auxiliary device that includes an optical amplifier configured to be connected between the partially functional transmit degree port and an optical fiber carrying the first wave division multiplexed optical signal.

Likewise, the partially functional receive degree port may be configured to be in optical communication with an auxiliary device that includes an optical amplifier configured to be connected between the partially functional receive degree port and an optical fiber carrying the second wave division multiplexed signal.

In one possible configuration the apparatus comprises 4 fully functional transmit degree ports, 4 fully functional receive degree ports, 16 channel receive ports and 16 channel transmit port, 8 partially functional transmit degree ports, and 8 partially functional receive degree ports.

When combined with a first auxiliary device that converts the at least one partially functional transmit degree port and the at least one partially functional receive degree port to, respectively, at least one fully functional transmit degree port and at least one fully functional receive degree port, the apparatus may operate as an 8 degree by 16 channel contentionless reconfigurable optical add/drop module, and when combined with the first auxiliary device and second auxiliary device having a same configuration as the first auxiliary device, the apparatus may operate as a 12 degree by 16 channel contentionless reconfigurable optical add/drop module.

Although the system and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following.

What is claimed is:

1. An apparatus comprising:
a first set of optical switches configured to receive respective first optical signals, at respective channel receive ports, to be added to a first wave division multiplexed optical signal and to direct the first optical signals to, in a first state, at least one fully functional transmit degree port, and in a second state, to at least one partially functional transmit degree port; and
a second set of optical switches configured to receive respective second optical signals to be dropped from a second wave division multiplexed signal via, in a first state, a fully functional receive degree port, and in a second state, via a partially functional receive degree port, and to direct the second optical signals to respective channel transmit ports.

2. The apparatus of claim 1, wherein the at least one fully functional transmit degree port comprises an optical coupler and an optical amplifier arranged in series.

3. The apparatus of claim 1, wherein the at least one fully functional receive degree port comprises an optical amplifier and an optical splitter arranged in series.

4. The apparatus of claim 1, wherein the at least one partially functional transmit degree port does not comprise an optical amplifier.

5. The apparatus of claim 4, wherein the partially functional transmit degree port is configured to be in optical communication with an auxiliary device that includes an optical amplifier configured to be connected between the partially functional transmit degree port and an optical fiber carrying the first wave division multiplexed optical signal.

6. The apparatus of claim 1, wherein the partially functional receive degree port does not comprise an optical amplifier.

7. The apparatus of claim 6, wherein the partially functional receive degree port is configured to be in optical communication with an auxiliary device that includes an optical amplifier configured to be connected between the partially functional receive degree port and an optical fiber carrying the second wave division multiplexed signal.

8. The apparatus of claim 1, wherein the apparatus comprises 4 fully functional transmit degree ports, 4 fully functional receive degree ports, 16 channel receive ports and 16 channel transmit ports.

9. The apparatus of claim 1, wherein the apparatus comprises 8 partially functional transmit degree ports, 8 partially functional receive degree ports, 16 channel receive ports and 16 channel transmit ports.

10. The apparatus of claim 1, wherein the apparatus is configured as a contentionless reconfigurable optical add/drop module.

11. The apparatus of claim 1, wherein respective ones of the first or the second optical signals have different bandwidths from one another.

12. The apparatus of claim 1, wherein the apparatus, when combined with a first auxiliary device that converts the at least one partially functional transmit degree port and the at least one partially functional receive degree port to, respectively, at least one fully functional transmit degree port and at least one fully functional receive degree port, operates as an 8 degree by 16 channel contentionless reconfigurable optical add/drop module.

13. The apparatus of 12, wherein the apparatus, when combined with the first auxiliary device and second auxiliary device having a same configuration as the first auxiliary device, operates as a 12 degree by 16 channel contentionless reconfigurable optical add/drop module.

14. An apparatus comprising:
a receive channel port;
a plurality of output ports comprising a first set of fully functional output ports and a second set of partially functional output ports;
a first optical switch arranged to be connected on one end with the receive channel port, and on another end with any one of the fully functional output ports and the partially functional output ports;
a transmit channel port;
a plurality of input ports comprising a first set of fully functional input ports and a second set of partially functional input ports; and
a second optical switch arranged to be connected on one end with the transmit channel port and on another end with any of the fully functional input ports and the partially functional input ports.

15. The apparatus of claim 14, wherein the apparatus is an optical add/drop module.

16. The apparatus of claim 15, wherein the apparatus is configured as a 4 degree by 16 channel optical add/drop module when taking into account only the fully functional output ports and input ports.

17. The apparatus of claim 16, wherein the apparatus is configured as a 12 degree by 16 channel optical add/drop module when taking into account both the fully functional output ports and input ports and partially functional output and input ports.

18. A method comprising:
receiving a first optical signal at an optical add/drop module;
routing the first optical signal, within the optical add/drop module, to an optical port thereof that includes a first optical coupler and a first optical amplifier;
receiving a second optical signal at the optical add/drop module;
routing the second optical signal, within the optical add/drop module, to an optical port thereof that includes a second optical coupler but does not include an optical amplifier to obtain a coupled optical signal including the second optical signal; and
routing the coupled optical signal including the second optical signal to a device external to the optical add/drop module that includes a second optical amplifier.

19. The method of claim 18, further comprising deploying the optical add/drop module and the device external to the optical add/drop module in a same equipment rack.

20. The method of claim 18, further comprising routing the coupled optical signal to a splitter/coupler component or a reconfigurable optical add/drop module node.
